(19) United States
(12) Patent Application Publication
(10) Pub. No.: US 2014/0211529 A1
(43) Pub. Date: Jul. 31, 2014

(54) METHODS AND SYSTEMS FOR OPERATING A BI-DIRECTIONAL MICRO INVERTER

(71) Applicant: GENERAL ELECTRIC COMPANY, Schenectady, NY (US)

(72) Inventors: Jeyaprakash Kandasamy, Hyderabad (IN); Remesh Kumar Keeramthode, Secunderabad (IN); NVS Kumar Srighakollapu, Hyderabad (IN)

(73) Assignee: General Electric Company, Schenectady, NY (US)

(21) Appl. No.: 13/751,704

(22) Filed: Jan. 28, 2013

(51) Int. Cl. H02M 7/797; G05F 1/70

(52) U.S. Cl. CPC H02M 7/797; G05F 1/70
USPC 363/131; 323/207

(57) ABSTRACT

A micro inverter includes a synchronous bi-directional power converter and a controller communicatively coupled to the synchronous bi-directional power converter. The controller is configured to operate the micro inverter in a forward conduction mode when photovoltaic (PV) power is available and operate the micro inverter in at least one of a reverse conduction mode and a reactive power compensation mode when PV power is unavailable.

### BACKGROUND

The present application relates generally to operating a micro inverter, and more specifically, to a synchronous bi-directional power converter for use in a micro inverter.

Sun is a potential source of renewable energy that is becoming increasingly attractive as an alternative source of energy. Solar energy in the form of irradiance may be converted to electrical energy using solar cells. A more general term for devices that convert light to electrical energy is “photovoltaic cells.” The electrical energy output of a photovoltaic (“PV”) cell is in the form of direct current (“DC”). In order for this DC output to be utilized by at least some conventional alternating current (“AC”) electronic devices, as well as the electric power grid, it must first be converted from DC to AC. Conventionally, this DC to AC conversion is performed with a power converter.

One type of solar power converter, a micro inverter, converts DC electricity from a single solar panel to AC. Conventionally, several solar panels are combined and connected to a string or central inverter which feeds the electric power into an electrical distribution network, or “grid”. In contrast, with the central inverters, micro inverters feed electric power from a single solar panel to the grid. Moreover, at least some known micro inverters are bi-directional and can transfer power from the grid to a desired device or application.

For example, one known bi-directional device uses a DC to AC flyback inverter topology as a micro inverter. However, such device needs a high input ripple current from an input capacitor, resulting in the use of electrolytic capacitors, which may be bulky and less reliable. Because of the large input ripple current, a larger sized transformer is used, causing incompact and reduced efficiency of the micro inverter.

Other known bi-directional devices include a DC to DC conversion device coupled to a DC to AC conversion device. Input ripple current for such DC to DC conversion device coupled to a DC to AC conversion device is reduced compared to using a DC to AC flyback inverter, so reliance on electrolytic capacitors may be reduced.

### BRIEF DESCRIPTION

In one aspect, a micro inverter is provided that includes a synchronous bi-directional power converter and a controller communicatively coupled to the synchronous bi-directional power converter. The controller is configured to operate the micro inverter in a forward conduction mode when photovoltaic (PV) power is available and operate the micro inverter in at least one of a reverse conduction mode and a reactive power compensation mode when PV power is unavailable.

In another aspect, a method is provided for operating a micro inverter having a synchronous bi-directional power converter coupled to a direct current DC power source and to an electrical grid. The method includes synchronously operating, using a controller, the micro inverter in a forward conduction mode when PV power is available from the DC power source and synchronously operating, using the controller, the micro inverter in at least one of a reverse conduction mode and a reactive power compensation mode when PV power is unavailable.

In yet another aspect, a controller is provided for use in controlling a micro inverter. The controller is configured to operate the micro inverter in a forward conduction mode when photovoltaic PV power is available and operate the micro inverter in at least one of a reverse conduction mode and a reactive power compensation mode when PV power is unavailable.

### DRAWINGS

FIG. 1 is a schematic diagram of an exemplary power distribution system that includes a plurality of solar panels that convert energy received from sunlight into direct current (DC) power.

FIG. 2 is a schematic block diagram of an exemplary system for controlling a micro inverter coupled to a solar panel.

FIG. 3 is a graph showing voltage and current for four modes of operation of a micro inverter during reactive power compensation mode.

FIG. 4 is a schematic diagram of an exemplary power converter.

FIG. 5 illustrates exemplary switching sequences for the bi-directional converter shown in FIG. 4 for continuous conduction mode (CCM) and discontinuous conduction mode (DCM) during forward conduction mode.

FIG. 6 is an exemplary flow diagram of the operation of main and synchronous switches of the bi-directional converter and bi-directional inverter shown in FIG. 4 during forward conduction mode.

FIG. 7 illustrates exemplary switching sequences for the bi-directional inverter shown in FIG. 4 during forward conduction mode.

### DETAILED DESCRIPTION

The methods and systems described herein provide a photovoltaic (PV) micro inverter that has active and reactive power generation capabilities. More specifically, the methods and systems described herein enable operation of a synchronous bi-directional power converter in four quadrant modes to achieve bi-directional power flow. The power converter operates in a forward conduction mode when PV power is available and in a reverse conduction mode or reactive power compensation mode when PV power is unavailable. A boost converter reduces ripple voltage within the power converter, eliminating a need for electrolytic capacitors, which improves reliability. Peak and RMS currents flowing through a transformer of the power converter are reduced, enabling a transformer smaller in size to be used. Additionally, synchronous switches are utilized in the power converter, resulting in improved efficiency of the micro inverter.

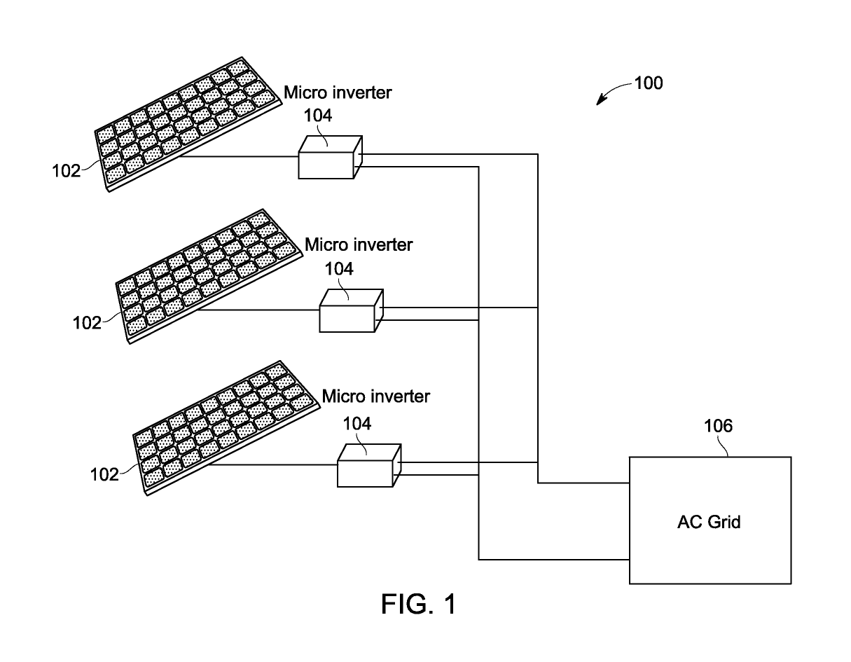

FIG. 1 is a schematic diagram of an exemplary power distribution system 100 that includes a plurality of direct current (DC) power sources 102, or solar panels, that convert energy received from sunlight into DC power. In an exemplary embodiment, each solar panel 102 is coupled to a micro inverter 104 that converts the DC power from the associated solar panel 102 into alternating current (AC) power. The AC power is provided to an AC grid 106 to power one or more devices.

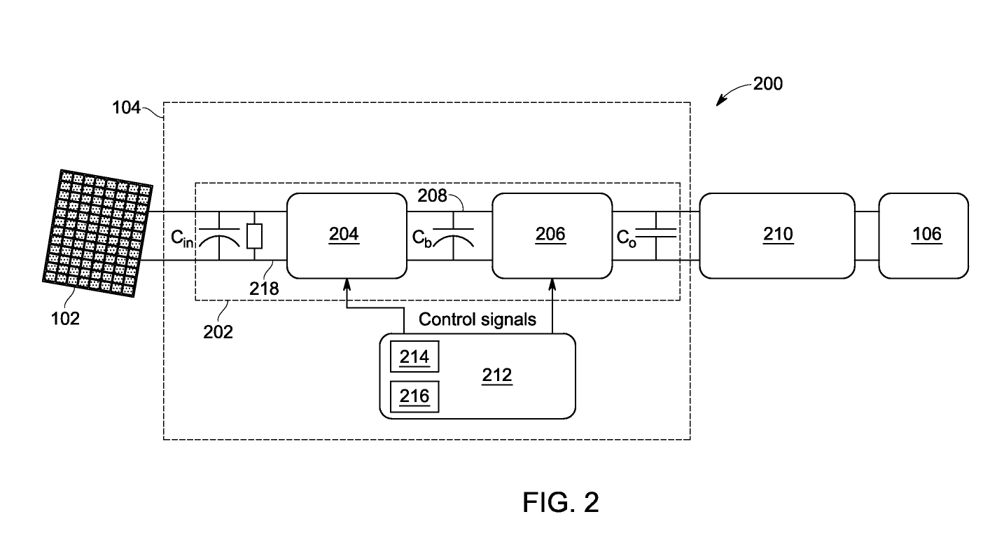

FIG. 2 is a schematic block diagram of an exemplary system 200 for controlling micro inverter 104 coupled to solar panel 102. System 200 may be used with power distribution system 100 (shown in FIG. 1). In an exemplary embodiment, solar panel 102 includes one or more of a photovoltaic (PV) panel, or any other device that converts solar energy to electrical energy. As described above, in an exemplary embodiment, each solar panel 102 generates DC power as a result of solar energy striking solar panels 102.

In an exemplary embodiment, micro inverter 104 includes a synchronous bi-directional power converter system 202, or a synchronous bi-directional power converter 202. In an exemplary embodiment, synchronous bi-directional power converter 202 is a two-stage power converter that includes a bi-directional DC to DC boost converter 204 and a bi-directional DC to AC inverter 206. Although illustrated as a two-stage power converter, system 200 may include a single-stage power converter, a multiple-stage power converter, and/or any suitable power converter that allows system 200 to function as described herein.

DC power generated by solar panel 102 is transmitted to synchronous bi-directional power converter 202, which converts the DC power to AC power. The AC power is transmitted to grid 106. Synchronous bi-directional power converter 202, in an exemplary embodiment, adjusts an amplitude of the voltage and/or current of the converted AC power to an amplitude suitable for grid 106, and provides AC power at a frequency and a phase that are substantially equal to the frequency and phase of grid 106. Moreover, in an exemplary embodiment, synchronous bi-directional power converter 202 provides single phase AC power to grid 106.

In an exemplary embodiment, synchronous bi-directional power converter 202 includes bi-directional DC to DC, or “boost,” converter 204. An input capacitor Cᵢₙ is coupled in parallel with solar panel 102 to supply an input voltage to bi-directional boost converter 204. Bi-directional converter 204 is configured to output a ripple current to bi-directional inverter 106.

In an exemplary embodiment, synchronous bi-directional power converter 202 includes synchronous bi-directional DC to AC, or “flyback,” inverter 206 coupled downstream from bi-directional boost converter 204 by a DC bus 208. Moreover, in an exemplary embodiment, DC bus 208 includes at least one bus capacitor C_{b}. Alternatively, DC bus 208 includes a plurality of capacitors C_{b} and/or any other electrical power storage devices that enable power distribution system 100 to function as described herein.

Synchronous bi-directional inverter 206 is coupled to a filter 210 by an output capacitor Cₒ. Moreover, in an exemplary embodiment, filter 210 is coupled to grid 106 (shown in FIGS. 1 and 2).

Synchronous bi-directional power converter 202 also includes a controller 212 coupled to synchronous bi-directional converter 204 and/or to synchronous bi-directional inverter 206. In an exemplary embodiment, controller 212 includes at least one processing device 214 and a memory 216. As used herein, the term “controller” includes any suitable programmable circuit such as, without limitation, one or more systems and microcontrollers, microprocessors, reduced instruction set circuits (RISC), application specific integrated circuits (ASIC), programmable logic circuits (PLC), field programmable gate arrays (FPGA), and/or any other circuit capable of executing the functions described herein. The above examples are exemplary only, and thus are not intended to limit in any way the definition and/or meaning of the term “controller.”

Memory 216 stores program code and instructions, executable by processing device 214, to control and/or monitor various functions of micro inverter 104. In an exemplary embodiment, memory 216 is an electrically erasable programmable read only memory (EEPROM). Alternatively, memory 216 may be any suitable storage medium, including, but not limited to non-volatile RAM (NVRAM), magnetic RAM (MRAM), ferroelectric RAM (FeRAM), read only memory (ROM), and/or flash memory. Any other suitable magnetic, optical and/or semiconductor memory, by itself or in combination with other forms of memory, may be included in memory 216. Memory 216 may also be, or include, a detachable or removable memory, including, but not limited to, a suitable cartridge, disk, CD ROM, DVD or USB memory.

According to an exemplary embodiment, controller 212 is configured to generate and to send pulse width modulation (PWM) signals to synchronous bi-directional power converter 202. In place of the PWM signals, any conversion signals suitable for enabling DC to AC conversion can be employed. The PWM signals are used to control the formation of an AC waveform from a DC waveform.

Controller 212 is configured to perform control operations in an exemplary embodiment including maximum power point tracking (MPPT), grid synchronization, anti-islanding, output current control, diagnostic monitoring and safety monitoring. Maximum power point tracking is a control method used to maximize a power output of solar panels 102. Grid synchronization is a function that facilitates matching the output of synchronous bi-directional power converter 202 to an electric grid 106, such as AC grid 106 (shown in FIG. 1). Anti-islanding functionality causes the independent sources to be disconnected from electric grid 106, when the utility power generator is disconnected from electric grid 106. Output current control functionality facilitates offloading desired output current magnitude and phase to grid 106 based on the maximum peak input power available from solar panel 102.

In an exemplary embodiment, micro inverter 104 has three operating levels of operation: continuous conduction mode (CCM), discontinuous conduction mode (DCM) and critical conduction mode. In an exemplary embodiment, controller 212 controls operation of micro inverter 104, and switches operation between CCM, DCM, and critical conduction mode based on power converter design parameters such as flyback inductance value of micro inverter 104, as described in detail herein. Alternatively, any processing device and/or controller that enables micro inverter 104 to function as described herein may control operation of micro inverter 104.

Moreover, in an exemplary embodiment, controller 212 is configured to determine a power operating point that is provided for controlling operation of synchronous bi-directional power converter 202. For example, a maximum power point (MPP) may be determined by controller 212 using MPPT. Controller 212 provides a power operating point signal corresponding to the MPP to synchronous bi-directional converter 204, and in response, synchronous bi-directional converter 204 is configured to extract a maximum power available from solar panel 102.

Moreover, in an exemplary embodiment, controller 212 controls and/or operates synchronous bi-directional inverter 206 to regulate the voltage across DC bus 208 and/or to adjust the voltage, current, phase, frequency, power factor, and/or any other characteristic of the power output from synchronous bi-directional inverter 206 to substantially match the characteristics of grid 106.

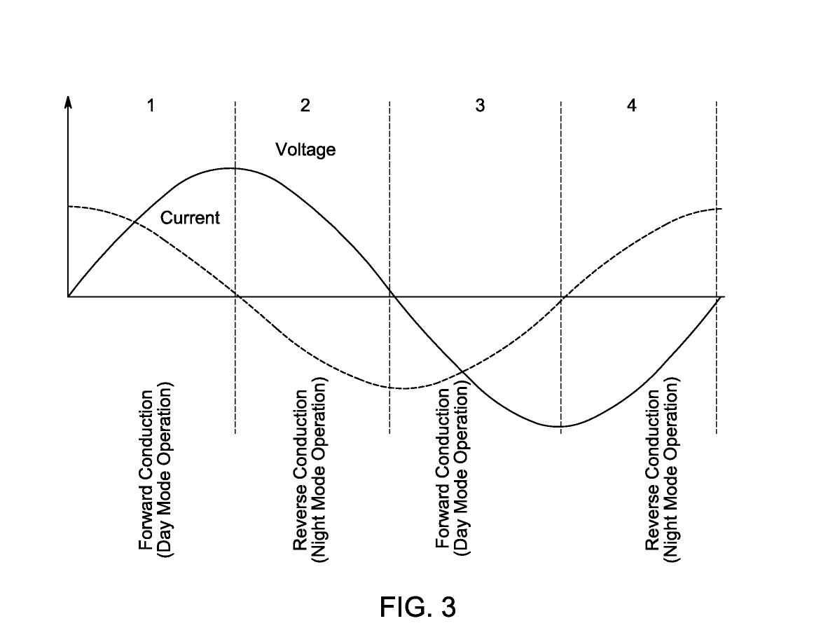

FIG. 3 shows voltage and current waveforms for four quadrants of operation of synchronous bi-directional power converter 202 during reactive power compensative mode. In an exemplary embodiment, synchronous bi-directional power converter 202 is a four-quadrant converter. Such four-quadrant converter is configured to operate in all four quadrants graphically represented by positive and negative voltages and currents (as shown in FIG. 3). Therefore, synchronous bi-directional power converter 202 facilitates four-quadrant power flow therethrough. Alternatively, synchronous bi-directional power converter 202 is any converter that has any electrical ratings that enable operation of system 200 as described herein including, without limitation, multiple two-quadrant inverters and/or multiple single quadrant inverters configured to transmit positive and/or negative real current and positive and/or negative reactive current. Moreover, such an optimum injection of real current and reactive current as described herein is generated by a variety of inverter assembly control schemes and topologies including, without limitation, current controlled source schemes and voltage controlled source schemes. In an exemplary embodiment, controller 212 is configured to independently control operation of synchronous bi-directional converter 204 and of synchronous bi-directional inverter 206 in four quadrant modes by which a bidirectional power flow is achieved. More specifically, in an exemplary embodiment, controller 212 operates in at least two modes: a forward conduction mode during daytime when solar panel 102 is capable of supplying power to grid 106, and a reverse conduction mode during nighttime when solar panel 102 is incapable of supplying power to grid 106. Forward conduction mode and reverse conduction mode each include a positive half cycle AC and a negative half cycle AC, which make up the four quadrants of operation. In an exemplary embodiment, controller 212 controls operation of micro inverter 104, and switches operation between the forward conduction mode and the reverse conduction mode of micro inverter 104, as described in detail herein. Alternatively, any processing device and/or controller that enables micro inverter 104 to function as described herein may control operation of micro inverter 104. A switching pattern for forward conduction mode is executed when voltage and current are in the same direction (i.e., quadrants 1 and 3). Alternatively, a switching pattern for reverse conduction mode is executed when voltage and current are in the opposite direction (i.e., quadrants 2 and 4).

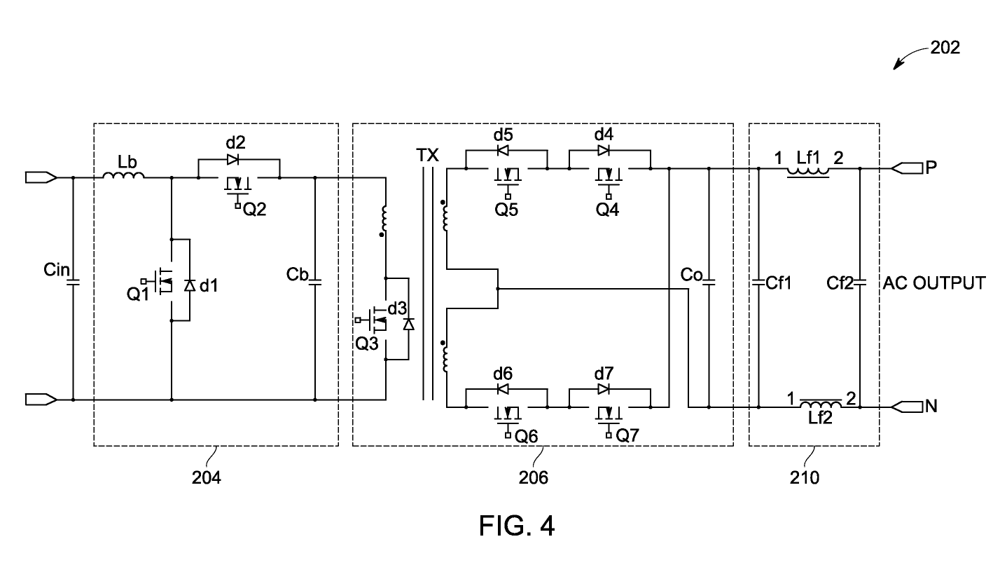

FIG. 4 is a schematic diagram of an exemplary synchronous bi-directional power converter 202 (shown in FIG. 2). Unless otherwise specified, elements shown in FIG. 4 are substantially identical to the elements shown in FIG. 2 and will be described herein using the same reference numerals. In an exemplary embodiment, synchronous bi-directional power converter 202 includes synchronous bi-directional converter 204 coupled to solar panel 102 and to synchronous bi-directional inverter 206. Synchronous bi-directional converter 204 includes a boost inductor L_{b}, a main switch Q1 coupled to an output of boost inductor L_{b}, an antiparallel diode d1 across main switch Q1, a synchronous boost switch Q2 coupled to an output of boost inductor L_{b}, an antiparallel diode d2 across synchronous switch Q2, and bus capacitor C_{b}. Unless otherwise stated, any switch described herein may be either a metal-oxide-semiconductor field-effect transistor (MOSFET) or an insulated-gate bipolar transistor (IGBT) or any other semiconductor device that enables operation described herein.

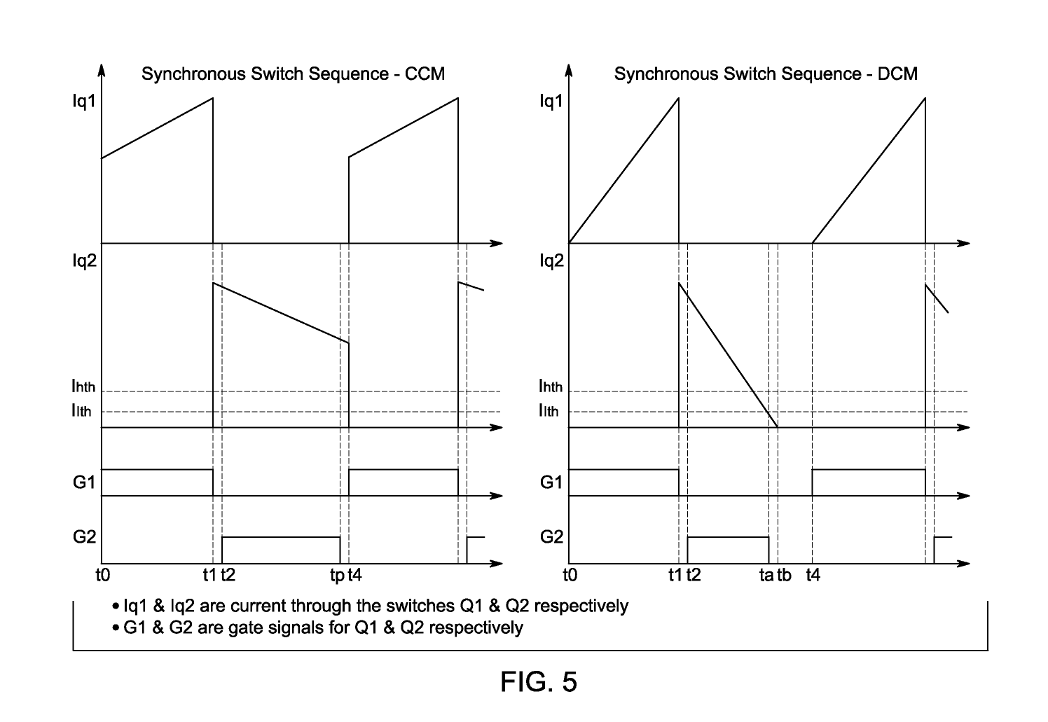

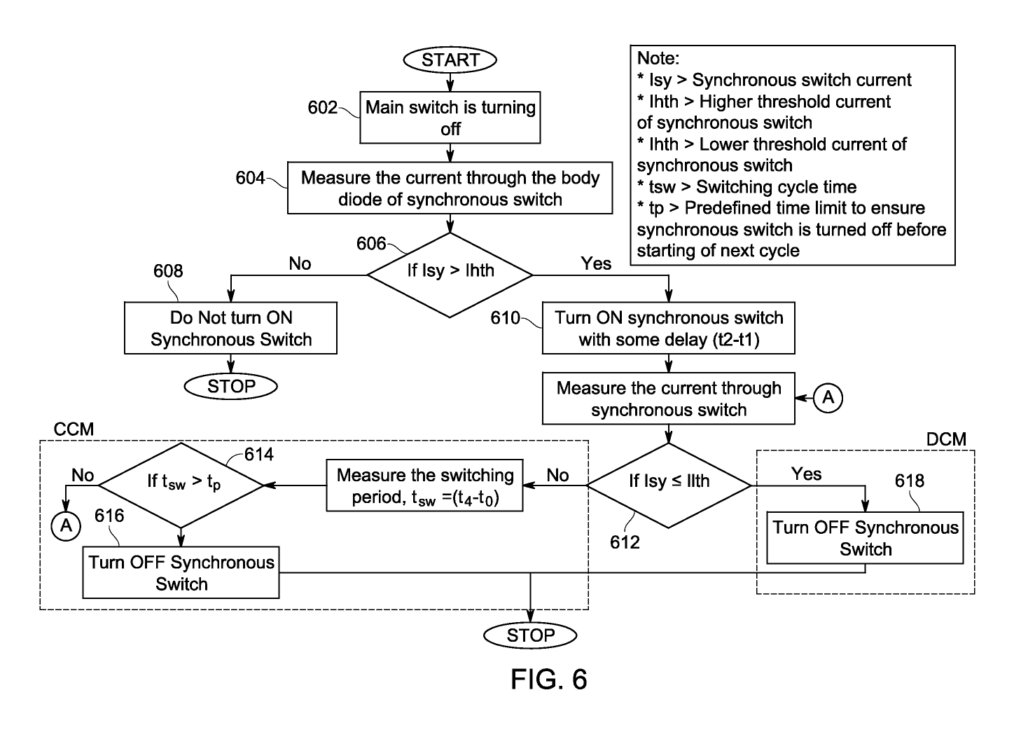

FIG. 5 illustrates exemplary switching sequences for synchronous bi-directional converter 204 for CCM and DCM during forward conduction mode. FIG. 6 is an exemplary flow diagram of the operation of switches Q1 and Q2 during forward conduction mode. In an exemplary embodiment, during forward conduction mode, synchronous bi-directional converter 204 is configured to convert variable input voltage from solar panel 102 to a fixed output voltage, and deliver the fixed output voltage to synchronous bi-directional inverter 206.

Referring to FIGS. 4-6, during steady state operation, boost inductor L_{b} stores energy while main switch Q1 is on. While Q1 is switched on, Q2 remains switched off and diode d2 is reverse biased. While Q2 is off, C_{b} supplies power to synchronous bi-directional inverter 206.

When main switch Q1 is turned off at time t1 (block 602), d2 becomes forward biased and begins to conduct, causing secondary switching currents to flow through d2. The secondary current is sensed by a current sensor (block 604) coupled in series with Q2. The current through synchronous switch Q2 is compared to a higher threshold current Iₕₜₕ of switch Q2 at block 606. Q2 is not turned on if synchronous current is less than Iₕₜₕ (block 608). Q2 is turned on when synchronous current rises above Iₕₜₕ (block 610) at time t₂. While Q2 is switched on, energy stored in L_{b} is delivered to synchronous bi-directional inverter 206. Additionally, energy from L_{b} is used to charge capacitor C_{b}. When both switches Q1 and Q2 are turned off, which typically happens during DCM, C_{b} supplies the required current for synchronous bi-directional inverter 206.

In an exemplary embodiment, at the end of each switching period during CCM, Q2 is turned off (block 616), either when one of a lower threshold Iₗₜₕ (block 612) and a predefined time (tₚ) limit is reached (block 614), whichever is earlier. At the end of the switching period, if current through the switch is continuous, Q2 is forcefully turned off when switching time t_{sw} reaches the predefined time limit tₚ. For example, if t_{sw} is 10 μs, then Q2 may be switched off at 9.8 μs (if 9.8 μs is predetermined time (tₚ) for safe operation) for CCM. The 0.2 μs “dead-time” ensures that Q2 is turned off in advance of Q1 being switched on at the beginning of the next switching cycle.

In an exemplary embodiment, at the end of each switching period during DCM, current flowing through Q2 decreases below Iₗₜₕ (block 612) before the end of the switching period t_{sw}. At time tₐ, Q2 is switched off (block 618) to ensure Q2 is turned off when current reaches zero at time t_{b}. When both switches Q1 and Q2 are turned off, capacitor C_{b} supplies the required current for synchronous bi-directional inverter 206.

If synchronous bi-directional converter 204 is operating in critical conduction mode, switch Q2 is turned off depending on the earlier of the typical predefined time limit (tₚ) before next switching time starts and the detection of Iₗₜₕ. This operation ensures that Q2 is turned off when Q1 is turned on at the start of the next switching cycle in all the three conduction modes CCM, DCM, & critical conduction mode.

In an exemplary embodiment, during operation, synchronous bi-directional converter 204 provides a continuous input current that is much smaller than known power distribution systems. Ripple current supplied by Cᵢₙ is also smaller than known systems, which enables the input capacitance value to be reduced from few milliFarads to microFarads. Accordingly, bulky, unreliable electrolytic capacitors used in known systems may be replaced by smaller, reliable film capacitors.

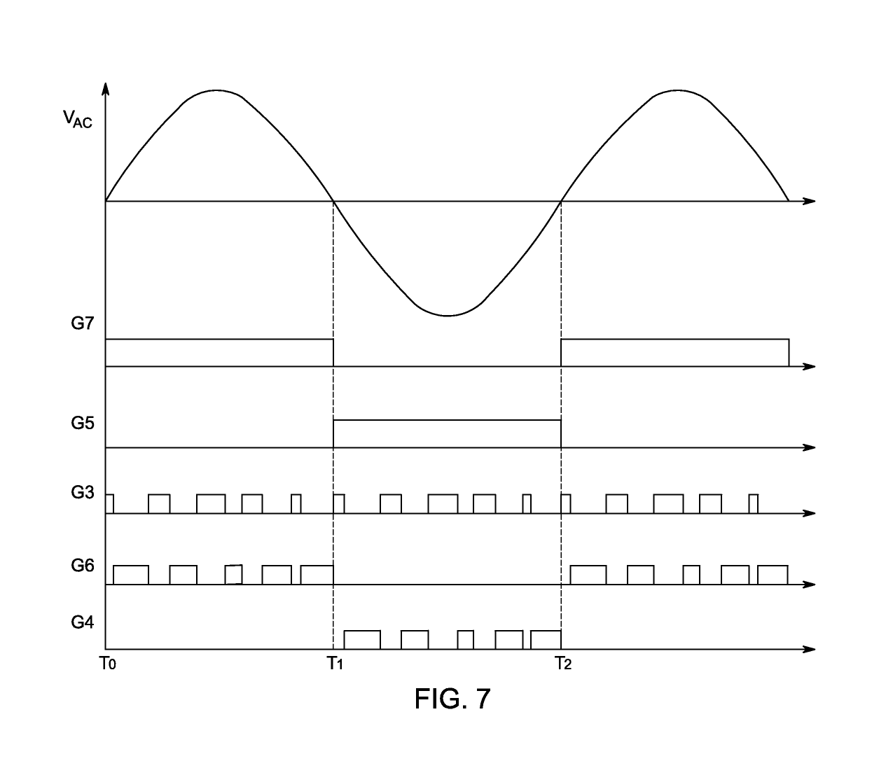

FIG. 7 illustrates exemplary switching sequences for synchronous bi-directional inverter 206 during forward conduction mode. Referring to FIGS. 4, 6, and 7, in an exemplary embodiment, synchronous bi-directional inverter 206 includes a primary flyback switch Q3 that operates at switching frequency and an antiparallel diode d3 across primary flyback switch Q3. Synchronous bi-directional inverter 206 also includes a flyback transformer TX having a single primary winding and first and second secondary windings. Primary flyback switch Q3 is coupled to the primary winding of transformer TX. A first secondary flyback switch Q5 is coupled to the first secondary winding of transformer TX. A first synchronous flyback switch Q6 is coupled to the second secondary winding of transformer TX. A second secondary flyback switch Q7 is coupled downstream from first synchronous flyback switch Q6. A second synchronous flyback switch Q4 is coupled downstream from first secondary flyback switch Q5. First and second secondary switches Q5 and Q7 are synchronized with output AC voltage and operate at line frequency. Synchronous switches Q4 and Q6 are synchronous switches that operate at switching frequencies. Synchronous bi-directional inverter 206 further includes antiparallel diodes d4, d5, d6 and d7 coupled across switches Q4, Q5, Q6 and Q7, respectively. Current flowing through switches Q4-Q7 is sensed by current sensors (not shown) coupled at the secondary side of synchronous bi-directional inverter 206. In an exemplary embodiment, controller 212 generates PWM pulses for primary flyback switch Q3 by comparing high frequency carrier signals with duty cycle magnitude.

During forward conduction mode, synchronous bi-directional inverter 206 operates during two cycles, a positive half cycle (T₀ to T₁) of alternating current (AC) and a negative half cycle of AC (T₁ to T₂).

In an exemplary embodiment, during the positive half cycle of AC, secondary switches Q6 and Q7 operate, and secondary switches Q4 and Q5 remain off for complete positive half cycle. Q7 remains switched on for the complete positive half cycle of AC (i.e., from T₀ to T₁). When Q3 is switched on, transformer TX stores energy. Additionally, while Q3 is on, Q6 remains off and diode d6 is reverse biased. While Q6 is off, capacitor C₀ supplies the output load.

When Q3 is turned off (block 602), d6 becomes forward biased and begins to conduct. Q6 turns on when synchronous current reaches Iₕₜₕ (block 610). At the end of each switching cycle, Q6 is turned off by the earlier of synchronous current reaching Iₗₜₕ (block 612) and reaching predefined time limit tₚ (block 614). When Q6 is turned off, if the current is continuous, d6 conducts at the end of the switching period.

When both switches Q3 and Q6 are turned off, typically during DCM, capacitor Cₒ supplies the required current for synchronous bi-directional inverter 206. The aforementioned operation repeats while Q7 is ON, which is during the positive half cycle.

In an exemplary embodiment, during the negative half cycle of AC, secondary switches Q4 and Q5 operate, and secondary switches Q6 and Q7 remains off for complete negative half cycle. Q5 remains on for the complete negative half cycle of AC (i.e., from T₁ to T₂). When Q3 is switched on, transformer TX stores energy. Additionally, while Q3 is on, Q4 remains turned off and diode d4 is reverse biased. While Q4 is off, capacitor C₀ supplies the output load.

When Q3 is turned off (block 602), d4 becomes forward biased and begins to conduct. Q4 turns on when current reaches Iₕₜₕ (block 610). At the end of each switching cycle, Q4 is turned off by the earlier of reaching Iₕₜₕ and reaching predefined time limit tₚ (block 614). When Q4 is turned off, if the current is continuous, d4 will conduct at the end of the switching period.

When both switches Q3 and Q4 are turned off, typically during DCM, capacitor Cₒ supplies the required current to the load for synchronous bi-directional inverter 206. The aforementioned operation repeats while Q5 is on, which is during the negative half cycle.

In CCM during forward conduction mode, current through switches Q4 and/or Q6 does not reach Iₗₜₕ at the end of the switching period. Accordingly, corresponding switches Q4 and/or Q6 are turned off forcefully when the predefined time limit tₚ is reached before starting the next switching cycle.

In DCM, current through switches Q4 and/or Q6 does reach Iₗₜₕ before the completion of switching period. Once it reaches Iₗₜₕ, switches Q4 and/or Q6 are turned off.

If synchronous bi-directional inverter 206 is operating at critical conduction mode, then the turnoff of switches Q4 and/or Q6 depends on either the predefined time limit tₚ or the detection of Iₗₜₕ, whichever is earlier. So, this operation ensures Q4 and/or Q6 are off when Q3 switches on at the next switching cycle in all the three conduction modes CCM, DCM, and critical conduction mode.

In an exemplary embodiment, synchronous bi-directional inverter 206 then delivers a single phase AC output to filter 210, which filters the AC output and delivers it to grid 106.

In an exemplary embodiment, during operation, the pulsating current provided by synchronous bi-directional converter 204 that flows through the primary winding of transformer TX depends on operating power, input voltage, switching frequency, duty cycle, and the inductance of the primary winding. Current in the primary winding is inversely proportional to the applied input voltage. Because synchronous bi-directional converter 204 increases input voltage delivered to synchronous bi-directional inverter 206, peak and root mean square (RMS) current through the primary winding is reduced. Accordingly, size of transformer TX may be reduced, while maintaining the same power level. Additionally, the turns ratio between the secondary and primary windings may also be reduced.

In an exemplary embodiment, synchronous bi-directional power converter 202 operates either in reverse conduction mode or reactive compensation mode during nighttime when power is unavailable from solar panel 102. In reverse conduction mode, a battery 218 (shown in FIG. 2) is charged using active power from grid 106.

In reactive power compensative mode, input capacitor Cᵢₙ acts as a reactive power compensator to deliver reactive power required by grid 106 for improving power quality. Generally, the load on grid 106 is an inductive load, which draws lagging current with respect to voltage from the grid power supply. The addition of a reactive component of current causes an increase in the apparent component of current. Such increased magnitude of current causes more losses in the power system (includes transmission, distribution and generation). In an exemplary embodiment, in a passive mode, reactive power compensation is achieved by adding parallel capacitors to draw leading current and compensate the lagging current, so that apparent current magnitudes decreases. Reactive current drawn by the capacitive currents is fixed with capacitor value and cannot be controlled. Alternatively, switching capacitors may be used to vary the magnitude of reactive power compensation. In another exemplary embodiment, in an active compensation mode, reactive power compensation is achieved by using inverters to send leading current to compensate the lagging current. Current magnitude and phase are controlled from zero to maximum and are limited by inverter rating. Such active mode of compensation necessitates four quadrant operation of bi-directional inverter 206. Additionally, the active mode necessitates a capacitor, for which capacitor Cᵢₙ is used.

In an exemplary embodiment, synchronous bi-directional inverter 206 continues to operate as a flyback inverter, but with reverse power flow. During reverse conduction mode, primary switch Q3 may be switched off because diode d3 conducts (or may be operated at switching frequency for synchronous rectifier operation) to convert AC power into DC power.

Switches Q6 and Q7 operate during the positive half cycle of AC and switches Q4 and Q5 operate during the negative half power cycle of AC. Secondary switches Q5 and Q7 are synchronized with AC grid 106 voltage and operate at power frequency. Switches Q4 and Q6 are main switches that operate at switching frequency. Controller 212 generates PWM signals by comparing duty cycle magnitude with high frequency carrier signal.

During the positive half cycle of AC grid 106 voltage, Q7 remains on for the complete positive half cycle of AC. When Q6 is switched on, transformer TX stores energy. Additionally, while Q6 is on, Q3 remains turned off and diode d3 is reverse biased. While Q3 is off, capacitor C_{b} supplies power to synchronous bi-directional converter 204.

When Q6 is turned off, d3 becomes forward biased and begins to conduct. Energy stored in TX is then delivered to synchronous bi-directional converter 204. Further, energy from TX is used to charge capacitor C_{b}. Alternatively, switch Q3 may remain off if synchronous rectifier operation is not active during reverse conduction mode. When both switches Q3 and Q6 are turned off, typically during DCM, capacitor C_{b} supplies the required current for synchronous bi-directional converter 204.

During the negative half cycle of AC grid 106 voltage, Q5 remains on for the complete negative half cycle of AC. When Q4 is switched on, transformer TX stores energy. Additionally, while Q4 is on, Q3 remains turned off and d3 is reverse biased. While Q3 is off, capacitor C_{b} supplies power to synchronous bi-directional converter 204.

When Q4 is turned off, d3 becomes forward biased and begins to conduct. Energy stored in TX is then delivered to synchronous bi-directional converter 204. Further, energy from TX is used to charge capacitor C_{b}. Alternatively, switch Q3 may remain off if synchronous rectifier operation is not active during reverse conduction mode. When both switches Q3 and Q4 are turned off, typically during DCM, capacitor C_{b} supplies the required current for synchronous bi-directional converter 204.

In an exemplary embodiment, during reverse conduction mode, synchronous bi-directional converter 204 operates as a buck converter, while synchronous bi-directional inverter 206 continues to operate as flyback inverter, but with reverse power flow. Switch Q2 operates as a main switch, which operates at a higher switching frequency. Switch Q1 may be switched off because diode d1 conducts (or is operated at switching frequency for synchronous rectifier operation).

During steady state operation, boost inductor L_{b} stores energy when Q2 is on. While Q2 is on, Q1 remains turned off and diode d1 is reverse biased. While Q1 is off, C_{b} supplies current to input capacitor Cᵢₙ. When Q2 is turned off, d1 becomes forward biased and begins to conduct. Energy stored in L_{b} is then delivered to battery 218. Alternatively, switch Q1 may remain off if synchronous rectifier operation is not active during reverse conduction mode.

In an exemplary embodiment, during reactive power compensative mode, synchronous bidirectional converter 204 operates in a buck or boost configuration depending on the quadrant of operation required for reactive power flow, while synchronous bidirectional inverter 206 continuous to operate as flyback inverter with forward or reverse power flow depending on the quadrant of operation required for reactive power flow. The ideal waveform for reactive power compensative mode is shown in FIG. 3.

Exemplary embodiments of a micro inverter and methods of operating a micro inverter are described above in detail. The micro inverter and methods are not limited to the specific embodiments described herein but, rather, components of the micro inverter and/or operations of the methods may be utilized independently and separately from other components and/or operations described herein. Further, the described components and/or operations may also be defined in, or used in combination with, other systems, methods, and/or devices, and are not limited to practice with only the power distribution system as described herein.

Technical effects of the methods and systems described herein include at least one of: (a) increasing micro inverter system reliability by removing bulk input electrolytic capacitors; (b) increasing efficiency of the power converter by using synchronous rectifier switches; and (c) reducing the size of the transformer, while achieving the same power level.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A micro inverter comprising:
a synchronous bi-directional power converter; and
a controller coupled to said synchronous bi-directional power converter, said controller configured to:
operate said micro inverter in a forward conduction mode when photovoltaic (PV) power is available; and
operate said micro inverter in at least one of a reverse conduction mode and a reactive power compensation mode when PV power is unavailable.

2. A micro inverter in accordance with claim 1, wherein said synchronous bi-directional power converter is configured to:
convert DC power to alternating current (AC) during the forward conduction mode; and
convert AC power to DC power during the reverse conduction mode.

3. A micro inverter in accordance with claim 2, wherein the DC power is applied to at least one of a reactive power compensator and a battery during the reverse conduction mode.

4. A micro inverter in accordance with claim 1, wherein said synchronous bi-directional power converter comprises:
a synchronous bi-directional DC to DC converter configured to receive power; and
a synchronous bi-directional DC to AC inverter coupled downstream from said bi-directional DC to DC converter.

5. A micro inverter in accordance with claim 4, wherein said controller is configured to generate pulse width modulation signals to control operation of said synchronous bi-directional DC to DC converter and said synchronous bi-directional DC to AC inverter.

6. A micro inverter in accordance with claim 4, wherein said synchronous bi-directional DC to DC converter comprises a DC to DC boost converter.

7. A micro inverter in accordance with claim 6, wherein said DC to DC boost converter is configured to output a ripple current to said synchronous bi-directional DC to AC inverter.

8. A micro inverter in accordance with claim 6, wherein said synchronous bi-directional DC to DC converter comprises:
a boost inductor;
a main boost switch coupled to said boost inductor; and
a synchronous boost switch coupled to said boost inductor.

9. A micro inverter in accordance with claim 8 wherein said main boost switch and said synchronous boost switch each comprise one of a metal-oxide-semiconductor field-effect transistor and an insulated-gate bipolar transistor.

10. A micro inverter in accordance with claim 4, wherein said synchronous bi-directional DC to AC inverter comprises a DC to AC flyback inverter.

11. A micro inverter in accordance with claim 10, wherein said synchronous bi-directional DC to AC inverter comprises:
a transformer having a primary winding and first and second secondary windings;
a primary flyback switch coupled to said primary winding;
a first secondary flyback switch coupled to said first secondary winding;
a first synchronous flyback switch coupled to said second secondary winding;
a second secondary flyback switch coupled downstream from said first synchronous flyback switch; and
a second synchronous flyback switch coupled downstream from said first secondary flyback switch.

12. A method of operating a micro inverter having a synchronous bi-directional power converter coupled to a direct current (DC) power source and to an electrical grid, said method comprising:
synchronously operating, using a controller, the micro inverter in a forward conduction mode when photovoltaic (PV) power is available from the DC power source; and
synchronously operating, using the controller, the micro inverter in at least one of a reverse conduction mode and a reactive power compensation mode when PV power is unavailable.

13. A method in accordance with claim 12, further comprising providing single phase AC power to the electrical grid.

14. A method in accordance with claim 12, further comprising providing reactive power compensation to the micro inverter during the reverse conduction mode.

15. A method in accordance with claim 12, further comprising charging a battery coupled to the micro inverter to the micro inverter during the reverse conduction mode.

16. A method in accordance with claim 12, further comprising:
converting DC power received from the DC power source to alternating current (AC) for delivery to the electrical grid during the forward conduction mode; and
converting AC power received from the electrical grid to DC power during the reverse conduction mode.

17. A controller for use in controlling a micro inverter, said controller configured to:
operate the micro inverter in a forward conduction mode when photovoltaic (PV) power is available; and
operate the micro inverter in at least one of a reverse conduction mode and a reactive power compensation mode when PV power is unavailable.

18. A controller in accordance with claim 17, further configured to:
convert DC power received from a DC power source to alternating current (AC) for delivery to an electrical grid during the forward conduction mode; and
convert AC power received from the electrical grid to DC power during the reverse conduction mode.

19. A controller in accordance with claim 18, wherein the DC power is applied to at least one of a reactive power compensator and a battery during the reverse conduction mode.

20. A controller in accordance with claim 17, wherein the micro inverter includes a synchronous bi-directional DC to DC converter and a synchronous bi-directional DC to AC inverter, said controller is further configured to generate pulse width modulation signals to control operation of the synchronous bi-directional DC to DC converter and the synchronous bi-directional DC to AC inverter.
